(19) United States
(12) Patent Application Publication
(10) Pub. No.: US 2015/0044604 A1
(43) Pub. Date: Feb. 12, 2015

(54) TONER FOR DEVELOPING ELECTROSTATIC IMAGES

(71) Applicant: ZEON CORPORATION, Tokyo (JP)

(72) Inventors: Hiromichi Jin, Tokyo (JP); Hiroshi Nakatani, Tokyo (JP)

(73) Assignee: ZEON CORPORATION, Tokyo (JP)

(21) Appl. No.: 14/388,109

(22) PCT Filed: Feb. 27, 2013
(86) PCT No.: PCT/JP2013/055218

§ 371 Date: Sep. 25, 2014

(30) Foreign Application Priority Data
Mar. 28, 2012 (JP) 2012-073449

(51) Int. Cl. G03G 9/097

(52) U.S. Cl. CPC G03G 9/09775
USPC 430/108.21

(57) ABSTRACT

The present invention provides a toner for developing electrostatic images, which is configured to keep excellent heat-resistant storage stability, increase charge stability against environmental changes, and show excellent stability even after a long period of storage. Disclosed is a toner for developing electrostatic images, comprising an external additive and colored resin particles comprising a binder resin, a colorant and a charge control agent, wherein the charge control agent is a positively-chargeable charge control agent, and wherein the toner further contains 80 to 500 ppm of a cyano group-containing hydrocarbon compound having a molecular weight of 100 to 300.

### TECHNICAL FIELD

The present invention relates to a toner for developing electrostatic images, which is configured to be used in image forming devices using electrophotography, such as a coping machine, a facsimile machine and a printer.

### BACKGROUND ART

Methods for forming a desired image by developing an electrostatic latent image with a toner for developing electrostatic images (hereinafter, “toner for developing electrostatic images” may be simply referred to as “toner”) have been widely used.

For example, in electrophotography, an electrostatic latent image formed on a photoconductor is developed with a toner made from colored particles optionally containing other particles of an external additive, carrier, etc. Then, the developed image is transferred onto a recording medium such as a paper or OHP sheet and then fixed to obtain a printed product.

There is an increasing need for color image forming devices using electrophotography, such as a color copying machine, color facsimile machine and color printer. In the formation of color images by full-color electrophotography, colors are reproduced with color toners of three colors, which are generally yellow, magenta and cyan, or with color toners of a total of four colors, which are the three colors and black. In the case of color copying, an image is formed by the following method, for example: first, a color image is read and decomposed into pixels and then converted to color digital image signals; light is applied onto a charged photoconductor to form an electrostatic latent image; then, the image is developed on the photoconductor, using color toners that correspond to color electrostatic latent image signals; finally, the image is transferred onto a recording medium such as a paper or OHP sheet.

In general, methods for producing toners used for development are broadly classified into a pulverization method and a polymerization method.

In the pulverization method, colored resin particles are produced by pulverizing and classifying a solid colored resin product, which is obtained by melt-kneading a binder resin and a colorant.

The polymerization method is a method for producing colored resin particles by forming and polymerizing droplets of a polymerizable monomer composition containing a polymerizable monomer and a colorant. While the form of the colored resin particles obtained by the pulverization method is not uniform, the form of the colored resin particles obtained by the polymerization method is close to a spherical form, and the particles have a small particle diameter and a narrow particle diameter distribution. Especially from the viewpoint of improving image properties such as image reproducibility and fineness, toners with a highly-controlled form and particle diameter distribution, like toners produced by the polymerization method (i.e., polymerized toner), have been increasingly used.

Various kinds of properties are required of toners, such as environmental stability from the viewpoint of preventing image deterioration due to changes in temperature, humidity, etc., printing durability from the viewpoint of reducing toner consumption, and low-temperature fixability from the viewpoint of reducing power consumption.

In the case of toners for developing electrostatic images, toner particles containing colored resin particles and an external additive attached thereto are charged and then supplied onto a photoconductor having an electrostatic latent image. Or, the toner particles and a member such as a developing blade are charged in between and then supplied onto a photoconductor having an electrostatic latent image, or the toner particles and a carrier are charged in between and then supplied onto a photoconductor having an electrostatic latent image. In this supplying step, the toner in an amount which corresponds to the charge density of the electrostatic latent image is attached onto the photoconductor. A high-quality image is formed when the toner is appropriately charged.

However, once a decrease or non-uniformity in toner charge amount is caused by environmental changes such as temperature change or humidity change, a desired electrostatic latent image cannot be developed on a photoconductor and results in problems such as fog, unevenness of images, and changes in image density.

To prevent variations in toner charge amount due to environmental changes, various kinds of charge control agents have been studied.

A toner composition is disclosed in Patent Literature the composition containing 0.0001 to 4% by mass of diethyl dimethyl succinonitrile. Also in Patent Literature 1, as a charge control agent, a toner containing a negatively-chargeable chromium complex is disclosed under “Examples”.

A toner for developing electrostatic images is disclosed in Patent Literature 2, the toner containing a specific, positively-chargeable polymeric charge control agent.

However, the toner disclosed in Patent Literature 1 is not able to sufficiently prevent variations in toner charge amount due to environmental changes. Especially at low temperature or low humidity, the toner is subjected to large environmental changes and results in an increase in fog production and a decrease in durability. The toner disclosed in Patent Literature 2 can partly prevent variations in toner charge amount due to environmental changes. However, there is such a problem that after a long period of storage, the toner is likely to be subjected to variations in toner charge amount due to environmental changes.

### CITATION LIST

Patent Literature 1: Japanese Patent Application Laid-Open (JP-A) No. H08-62898

Patent Literature 2: JP-A No. H11-15192

### SUMMARY OF INVENTION

### Technical Problem

An object of the present invention is to provide a toner for developing electrostatic images, which is configured to keep excellent heat-resistant storage stability, increase charge stability against environmental changes, and show excellent stability even after a long period of storage.

### Solution to Problem

As a result of diligent researches, the inventors of the present invention have found that the above object can be achieved by containing a positively-chargeable charge control agent in colored resin particles and containing a small amount of low-molecular-weight hydrocarbon compound that contains a cyano group (i.e., a negatively-chargeable functional group).

According to the present invention, a toner for developing electrostatic images is provided, the toner comprising an external additive and colored resin particles comprising a binder resin, a colorant and a charge control agent, wherein the charge control agent is a positively-chargeable charge control agent, and wherein the toner further contains 80 to 500 ppm of a cyano group-containing hydrocarbon compound having a molecular weight of 100 to 300.

In the present invention, the charge control agent is preferably a positively-chargeable charge control resin.

In the present invention, the charge control agent is preferably a charge control resin containing a quaternary ammonium base.

In the present invention, the cyano group-containing hydrocarbon compound preferably has a molecular structure represented by the following general formula (1):

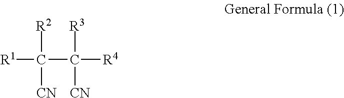

wherein R¹ to R⁴ each independently represent a hydrocarbon group having 1 to 4 carbon atoms.

In the present invention, the cyano group-containing hydrocarbon compound can have a molecular structure represented by the following general formula (2):

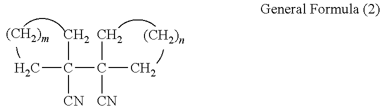

wherein “m” and “n” each independently represent an integer of 1 to 4.

In the present invention, the content of the cyano group-containing hydrocarbon compound is preferably 150 to 300 ppm.

### Advantageous Effects of invention

According to the present invention, the above-mentioned toner for developing electrostatic images, which is a toner with excellent storage stability and excellent environmental stability even after a long period of storage, can be provided by containing a positively-chargeable charge control agent in combination with a cyano group-containing hydrocarbon compound having a specific molecular structure and negatively charging property, which is a charging property that is opposite to a positively charging property.

### BRIEF DESCRIPTION OF DRAWINGS

FIG. 1 is a view showing an example of a system used for stripping treatment.

### DESCRIPTION OF EMBODIMENTS

The toner for developing electrostatic images according to the present invention contains an external additive and colored resin particles comprising a binder resin, a colorant and a charge control agent, wherein the charge control agent is a positively-chargeable charge control agent, and wherein the toner further contains 80 to 500 ppm of a cyano group-containing hydrocarbon compound having a molecular weight of 100 to 300.

Hereinafter, the toner of the present invention will be explained. The toner of the present invention contains: a binder resin, a colorant, a positively-chargeable charge control agent, a cyano group-containing hydrocarbon compound, and an external additive.

Hereinafter, a method for producing colored resin particles used in the present invention, colored resin particles obtained by the production method, a method for producing the toner of the present invention containing the colored resin particles, and the toner of the present invention, will be explained in order.

### 1. The Method for Producing Colored Resin Particles

The colored resin particles of the present invention can be produced by a wet or dry method. Of wet methods, a suspension polymerization method is preferred. The suspension polymerization method is preferably carried out by the following process.

### (A) Suspension Polymerization Method

### (A-1) Step of Preparing a Polymerizable Monomer Composition

First, a polymerizable monomer, a colorant, a positively-chargeable charge control agent, a cyano group-containing hydrocarbon compound and, as needed, other additive(s) such as a release agent, are mixed to prepare a polymerizable monomer composition. In the preparation of the polymerizable monomer composition, the mixing is conducted by, for example, a media type dispersing machine.

In the present invention, “polymerizable monomer” means a monomer having a polymerizable functional group, and the polymerizable monomer is polymerized into a binder resin. A monovinyl monomer is preferably used as a main component of the polymerizable monomer. Examples of monovinyl monomers include the following: styrene; styrene derivatives such as vinyl toluene and α-methylstyrene; acrylic acids and methacrylic acids; acrylic esters such as methyl acrylate, ethyl acrylate, propyl acrylate, butyl acrylate, 2-ethylhexyl acrylate and dimethylaminoethyl acrylate; methacrylic esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. These monovinyl monomers can be used alone or in combination of two or more kinds. Of these monovinyl monomers, preferably used are styrene, styrene derivatives, acrylic esters and methacrylic esters.

To prevent hot offset and improve storage stability, it is preferable to use the monovinyl monomer and an optional cross-linkable polymerizable monomer. The cross-linkable polymerizable monomer means a monomer having two or more polymerizable functional groups. Examples of cross-linkable polymerizable monomers include aromatic divinyl compounds such as divinylbenzene, divinylnaphthalene and derivatives thereof; ester compounds such as ethylene glycol dimethacrylate and diethylene glycol dimethacrylate, in which two or more carboxylic acids having a carbon-carbon double bond are esterified to an alcohol having two or more hydroxyl groups; other divinyl compounds such as N,N-divinylaniline and divinyl ether; and compounds having three or more vinyl groups. These cross-linkable polymerizable monomers can be used alone or in combination of two or more kinds.

In the present invention, the cross-linkable polymerizable monomer is generally used in an amount of 0.1 to 5 parts by mass, preferably 0.3 to 2 parts by mass, relative to 100 parts by mass of the monovinyl monomer.

It is also preferable to use a macromonomer further as a part of the polymerizable monomer, because the toner thus obtained has an excellent balance between storage stability and low-temperature fixability. A macromonomer is one having a polymerizable carbon-carbon unsaturated double bond at an end of a molecular chain thereof, and it is also a reactive oligomer or polymer generally having a number average molecular weight of 1,000 to 30,000. The macromonomer is preferably one that gives a polymer having a higher glass transition temperature (hereinafter may be referred to as “Tg”) than that of the polymer obtained by polymerizing the above-mentioned monovinyl monomer. The amount of the macromonomer is preferably used in an amount of 0.03 to 5 parts by mass, more preferably 0.05 to 1 part by mass, relative to 100 parts by mass of the monovinyl monomer.

A colorant is used in the present invention. In the case of producing a color toner, black, cyan, yellow and magenta colorants can be used.

As the black colorant, for example, there may be used carbon black, titanium black, and magnetic powders of zinc iron oxide, nickel iron oxide and so on.

As the cyan colorant, for example, there may be used copper phthalocyanine compounds, derivatives thereof, and anthraquinone compounds. Concrete examples include C.I. Pigment Blue 2, 3, 6, 15, 15:1, 15:2, 15:3, 15:4, 16, 17:1 and 60.

As the yellow colorant, for example, there may be used compounds including condensation polycyclic pigments and azo-based pigments such as monoazo pigments, disazo pigments, etc. Examples thereof include C.I. Pigment Yellow 3, 12, 13, 14, 15, 17, 62, 65, 73, 74, 83, 93, 97, 120, 138, 155, 180, 181, 185, 186 and 213.

As the magenta colorant, there may be used compounds including condensation polycyclic pigments and azo-based pigments such as monoazo pigments, disazo pigments, etc. Examples thereof include C.I. Pigment Violet 19 and C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269.

In the present invention, colorants can be used alone or in combination of two or more kinds. The colorant is preferably used in an amount of 1 to 10 parts by mass, relative to 100 parts by mass of the monovinyl monomer.

In the present invention, to increase the charge property of the toner, a positively-chargeable charge control agent is used. Examples of positively-chargeable charge control agents include the following: nigrosine dyes, quaternary ammonium salts, triaminotriphenylmethane compounds, imidazole compounds, polyamine resins (which are charge control resins preferably used), tertiary amino group-containing copolymers and quaternary ammonium base-containing copolymers. Of these positively-chargeable charge control agents, preferably used are positively-chargeable charge control resins, and it is more preferable to use a charge control resin containing a quaternary ammonium base.

In the present invention, the positively-chargeable charge control agent is generally used in an amount of 0.01 to 20 parts by mass, preferably 0.01 to 10 parts by mass, more preferably 0.03 to 8 parts by mass, relative to 100 parts by mass of the monovinyl monomer. When the amount of the positively-chargeable charge control agent added is less than 0.01 part by mass, fog may be produced. When the amount of the positively-chargeable charge control agent added is more than 20 parts by mass, soiling may occur.

A main characteristic of the present invention is to use the cyano group-containing hydrocarbon compound having a molecular weight of 100 to 300.

The structure of the cyano group-containing hydrocarbon compound used in the present invention is not particularly limited, as long as it is a structure that has at least one of straight-chain, branched-chain and cyclic hydrocarbon skeletons and that at least one hydrogen in the hydrocarbon skeleton has been substituted by a cyano group (—CN). In the present invention, cyano group is used synonymously with nitrile group.

The cyano group-containing hydrocarbon compound can contain a functional group(s) other than cyano group, such as a hydroxyl group (—OH), amino group (—NH₂), nitro group (—NO₂), fluoro group (—F), chloro group (—Cl), bromo group (—Br), iodo group (—I), etc. However, the number of the other functional group(s) is preferably two or less per molecule, more preferably one or less per molecule. It is more preferable that the cyano group-containing hydrocarbon compound contains no functional group other than cyano group.

The cyano group-containing hydrocarbon compound preferably contains one to three cyano groups per molecule, more preferably two cyano groups per molecule. When four or more cyano groups are contained per molecule, fog may be produced in low temperature and low humidity (L/L) environment.

The cyano group-containing hydrocarbon compound preferably has at least one quaternary carbon atom per molecule. A quaternary carbon atom means a carbon atom that is bound to four different carbon atoms by four bonds. In the present invention, the quaternary carbon atom can be bound to a carbon atom in the cyano group by a direct bond.

The cyano group-containing hydrocarbon compound is preferably a vicinal dicyano (vic-dicyano) compound. A vicinal dicyano compound means a compound having two cyano groups per molecule, each of which is bound to adjacent two carbon atoms. In this case, the adjacent two carbon atoms can be quaternary carbon atoms.

When the cyano group-containing hydrocarbon compound has a molecular weight of less than 100, durability and storage stability may be decreased. When the cyano group-containing hydrocarbon compound has a molecular weight of more than 300, environmental stability effects may be diminished.

More preferably, the cyano group-containing hydrocarbon compound has a molecular weight of 120 to 250, still more preferably 150 to 200.

The cyano group-containing hydrocarbon compound preferably has a branched-chain structure as represented by the following general formula (1), which is a structure that meets all of the following conditions mentioned above: the number of cyano groups; having a quaternary carbon atom; being a vicinal dicyano compound; and the above-mentioned molecular weight condition.

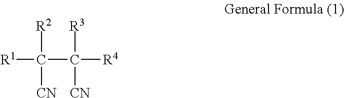

In the general formula (1), R¹ to R⁴ each independently represent a hydrocarbon group having 1 to 4 carbon atoms.

Concrete examples of the cyano group-containing hydrocarbon compound having the molecular structure represented by the general formula (1), include 2,3-diethyl-2,3-dimethylbutanedinitrile (CAS No. 128903-20-8, molecular weight 164, the following formula (1a)), 2,2,3,3-tetramethylbutanedinitrile (CAS No. 3333-52-6, molecular weight 136, the following formula (1b)), and 2,3-dimethyl-2,3-bis(2-methylpropyl)butanedinitrile (CAS No. 80822-82-8, molecular weight 220, the following formula (1c)).

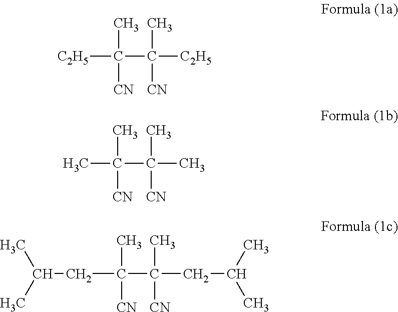

In the present invention, there may be used a cyano group-containing hydrocarbon compound having a cyclic structure as represented by the following general formula (2):

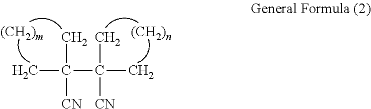

In the general formula (2), “m” and “n” each independently represent an integer of 1 to 4.

Concrete examples of the cyano group-containing hydrocarbon compound having the molecular structure represented by the general formula (2), include 1,1′-bicyclohexyl-1,1′-dicarbonitrile (CAS No. 18341-40-7, molecular weight 216, the following formula (2a)), 1,1′-bicyclopentyl-1,1′-dicarbonitrile(CAS No. 85688-88-6, molecular weight 188, the following formula (2b)), 1,1′-bicyclobutyl-1,1′-dicarbonitrile (molecular weight 160, the following formula (2c)), and 1,1′-bicycloheptyl-1,1′-dicarbonitrile (CAS No. 85688-89-7, molecular weight 244, the following formula (2d)).

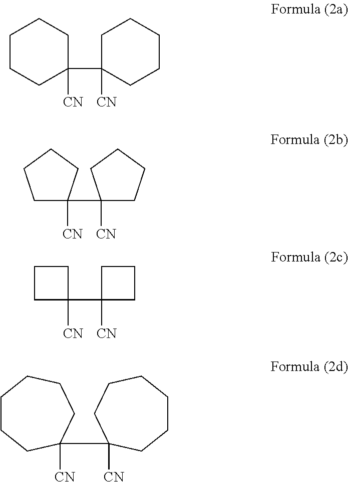

Details of the effects obtained by adding the cyano group-containing hydrocarbon compound, are not clear. However, it is presumed that the effects of the present invention, that is, excellent heat-resistant storage stability and printing durability, can be exerted by that the cyano group-containing hydrocarbon compound and the positively-chargeable charge control agent are close to each other, and by an interaction between the functional groups of the hydrocarbon compound and those of the charge control agent.

The cyano group-containing hydrocarbon compound used in the present invention can be one synthesized in advance or a commercially-available product.

The method for synthesizing the cyano group-containing hydrocarbon compound is not particularly limited and can be a known method. As the method for producing the cyano group-containing hydrocarbon compound, particularly as the method for producing the compound having the branched-chain structure represented by the general formula (1) or the method for producing the compound having the cyclic structure represented by the general formula (2), there may be mentioned a method for producing the compound by decomposing an azonitrile compound as typified by azobisisobutyronitrile, for example. Examples of the method for producing the compound by decomposition an azonitrile compound include the following: heat decomposition methods as disclosed in publicly known document (W. Barbe et al., Chem. Ber. 116, 1017-1041 (1983)), more specifically, in examples relating to compounds 7a to 7l, and heat decomposition methods as disclosed in Tables 4 to 6 of publicly known document 2 (C. G. Overberger et al., J. Am. Chem. Soc., 1949, 71(8), pp. 2661-2666); and reactions as disclosed in publicly known document 3 (M. C. Ford et al., J. Chem. Soc., 1952, 2240-2245), which are reactions with halogenating agents such as ωωω-tribromoquinaldine, N-Bromosuccinimide, etc. It is thought that the cyano group-containing hydrocarbon compound can be synthesized by other methods besides the above-described synthesizing method by decomposing the azonitrile compound, the methods including one as disclosed in scheme 1 of publicly known literature 4 (W. Barbe et al., Chem. Ber. 116, 1042-1057 (1983)), which is isomerization via a radical cleavage from ketenimine (compound 3a).

As the cyano group-containing hydrocarbon compound used in the present invention, for example, there may be used products commercially available from Achemica Corp., etc.

In the toner of the present invention, the cyano group-containing hydrocarbon compound is contained in an amount of 80 to 500 ppm. When the content of the cyano group-containing hydrocarbon compound is less than 80 ppm, as is clear from the below-described results of Comparative Examples 1 and 3, charge stability is deteriorated. On the other hand, when the content of the cyano group-containing hydrocarbon compound is more than 500 ppm, as is clear from the below-described results of Comparative Examples 2 and 4, the toner is poor in all of heat-resistant storage stability and printing durability.

In the toner of the present invention, the content of the cyano group-containing hydrocarbon compound is preferably 100 to 400 ppm, more preferably 120 to 300 ppm, still more preferably 150 to 250 ppm.

From the viewpoint of improving the releasing characteristics of the toner from a fixing roller upon fixing, it is preferable to add a release agent to the polymerizable monomer composition. The release agent is not particularly limited as long as it is one that is generally used as a release agent in toner.

The release agent preferably contains at least one of an ester wax and a hydrocarbon wax. By using these waxes as the release agent, a suitable balance between low-temperature fixability and storage stability can be obtained.

In the present invention, preferably used as the release agent is a polyfunctional ester wax. Examples thereof include: pentaerythritol ester compounds such as pentaerythritol tetrapalmitate, pentaerythritol tetrabehenate and pentaerythritol tetrastearate; glycerin ester compounds such as hexaglycerin tetrabehenate tetrapalmitate, hexaglycerin octabehenate, pentaglycerin heptabehenate, tetraglycerin hexabehenate, triglycerin pentabehenate, diglycerin tetrabehenate, and glycerin tribehenate; and dipentaerythritol ester compounds such as dipentaerythritol hexamyristate and dipentaerythritol hexapalmitate. Of them, preferred are dipentaerythritol ester compounds, and more preferred is dipentaerythritol hexamyristate.

Also in the present invention, preferably used as the release agent is a hydrocarbon wax. Examples thereof include a polyethylene wax, a polypropylene wax, a Fischer-Tropsch wax and a petroleum wax. Of them, preferred are a Fischer-Tropsch wax and a petroleum wax, and more preferred is a petroleum wax.

The hydrocarbon wax preferably has a number average molecular weight of 300 to 800, more preferably 400 to 600. The hydrocarbon wax preferably has a penetration of 1 to 10, more preferably 2 to 7, which is measured according to JIS K2235 5.4.

Besides the above release agents, for example, there may be used a natural wax such as jojoba and a mineral wax such as ozokerite.

As the release agent, the above-mentioned waxes can be used alone or in combination of two or more kinds.

The release agent is preferably used in an amount of 0.1 to 30 parts by mass, more preferably 1 to 20 parts by mass, relative to 100 parts by mass of the monovinyl monomer.

It is also preferable to use a molecular weight modifier as other additive, when polymerizing the polymerizable monomer into a binder resin.

The molecular weight modifier is not particularly limited, as long as it is one that is generally used as a molecular weight modifier for toner. Examples thereof include mercaptans such as t-dodecyl mercaptan, n-dodecyl mercaptan, n-octyl mercaptan and 2,2,4,6,6-pentamethylheptane-4-thiol; and thiuram disulfides such as tetramethylthiuram disulfide, tetraethylthiuram disulfide, tetrabutylthiuram disulfide, N,N′-dimethyl-N,N′-diphenylthiuram disulfide, and N,N′-dioctadecyl-N,N′-diisopropylthiuram disulfide. These molecular weight modifiers can be used alone or in combination of two or more kinds.

In the present invention, the molecular weight modifier is generally used in an amount of 0.01 to 10 parts by mass, preferably 0.1 to 5 parts by mass, relative to 100 parts by mass of the monovinyl monomer.

### (A-2) Suspension Step for Obtaining a Suspension (Droplets Forming Step)

In the present invention, the polymerizable monomer composition containing at least the polymerizable monomer, the colorant, the positively-chargeable charge control agent and the cyano group-containing hydrocarbon compound, is dispersed in an aqueous medium containing a dispersion stabilizer. After adding a polymerization initiator thereto, the polymerizable monomer composition is formed into droplets. The method for forming droplets is not particularly limited. For example, a machine which is capable of strong agitation is used, such as an (in-line) emulsification device (product name: MILDER; manufactured by Ebara Corporation), a high-speed emulsification device (product name: T.K. HOMO MIXER MARK II; manufactured by PRIMIX Corporation), etc.

As the polymerization initiator, for example, there may be mentioned persulfates such as potassium persulfate and ammonium persulfate; azo compounds such as 4,4′-azobis(4-cyanovaleric acid), 2,2′-azobis(2-methyl-N-(2-hydroxyethyl)propion amide), 2,2′-azobis(2-amidinopropane)dihydrochloride, 2,2′-azobis(2,4-dimethylvaleronitrile) and 2,2′-azobisisobutyronitrile; and organic peroxides such as di-t-butyl peroxide, benzoyl peroxide, t-butylperoxy-2-ethylhexanoate, t-butylperoxy-2-ethylbutanoate, t-hexylperoxy-2-ethylbutanoate, diisopropyl peroxydicarbonate, di-t-butylperoxy isophthalate and t-butylperoxy isobutyrate. They may be used alone or in combination of two or more kinds. Of them, preferably used are organic peroxides, because they can decrease polymerizable monomer residues and provide excellent printing durability.

Of organic peroxides, preferred are those containing no cyano group, more preferred are peroxyesters, and still more preferred are non-aromatic peroxyesters, i.e., peroxyesters containing no aromatic ring, because they can provide excellent polymerization initiation efficiency and decrease polymerizable monomer residues.

As described above, the polymerization initiator can be added after dispersing the polymerizable monomer composition in the aqueous medium and before forming droplets. Or, it can be added to the polymerizable monomer composition before dispersing the composition in the aqueous medium.

The added amount of the polymerization initiator, which is used for polymerization of the polymerizable monomer composition, is preferably 0.1 to 20 parts by mass, more preferably 0.3 to 15 parts by mass, still more preferably 1 to parts by mass, relative to 100 parts by mass of the monovinyl monomer.

In the present invention, “aqueous medium” means a medium which mainly consists of water.

In the present invention, the aqueous medium preferably contains a dispersion stabilizer. As the dispersion stabilizer, for example, there may be mentioned the following compounds: inorganic compounds including sulfates such as barium sulfate and calcium sulfate; carbonates such as barium carbonate, calcium carbonate and magnesium carbonate; phosphates such as calcium phosphate; metal oxides such as aluminum oxide and titanium oxide; and metal hydroxides such as aluminum hydroxide, magnesium hydroxide and iron(II)hydroxide; and organic compounds including water-soluble polymers such as polyvinyl alcohol, methyl cellulose and gelatin; anionic surfactants; nonionic surfactants; and ampholytic surfactants. These dispersion stabilizers can be used alone or in combination of two or more kinds.

Of the above dispersion stabilizers, preferred are inorganic compounds, and particularly preferred are colloids of hardly water-soluble metal hydroxides. By using such colloids, the particle diameter distribution of the colored resin particles can be adjusted to be narrow and, after washing, the amount of dispersion stabilizer residues can be decreased. Therefore, the toner thus obtained can sharply reproduce an image and shows excellent environmental stability.

### (A-3) Polymerization Step

Droplets are formed as described above under (A-2), and the thus-obtained aqueous dispersion medium is heated to initiate polymerization, thus producing an aqueous dispersion of the colored resin particles.

The polymerization temperature of the polymerizable monomer composition is preferably 50° C. or more, more preferably 60 to 95° C. The polymerization reaction time is preferably 1 to 20 hours, more preferably 2 to 15 hours.

The colored resin particles can be mixed with an external additive and then used as a toner. However, it is preferable to produce core-shell (or capsule) colored resin particles, by using the colored resin particles as the core layer and forming a shell layer outside the core layer. By covering the core layer, which is made of a substance having a low softening point, with a substance having a higher softening point, the core-shell colored resin particles can achieve a balance between lowering the fixation temperature and preventing aggregation during storage.

The method for producing the core-shell colored resin particles using the above-mentioned colored resin particles, is not particularly limited. The core-shell colored resin particles can be produced by conventionally-known methods. From the viewpoint of production efficiency, preferred are an in-situ polymerization method and a phase separation method.

Hereinafter, the method for producing the core-shell colored resin particles by the in-situ polymerization method, will be explained.

First, a polymerizable monomer for forming the shell layer (polymerizable monomer for shell) and a polymerization initiator are added to an aqueous medium for polymerization, in which the colored resin particles are dispersed, thereby obtaining the core-shell colored resin particles.

As the polymerizable monomer for shell, the above-mentioned polymerizable monomers can be used. Of them, it is preferable to use monomers which can provide a polymer having a Tg of more than 80° C., such as styrene, acrylonitrile and methyl methacrylate, alone or in combination of two or more kinds.

As the polymerization initiator that is used for polymerization of the polymerizable monomer for shell, for example, there may be mentioned water-soluble polymerization initiators including metal persulfates such as potassium persulfate and ammonium persulfate; and azo-based initiators such as 2,2′-azobis(2-methyl-N-(2-hydroxyethyl)propionamide) and 2,2′-azobis(2-methyl-N-(1,1-bis(hydroxymethyl)2-hydroxyethyl)propionamide). They can be used alone or in combination of two or more kinds. The polymerization initiator is preferably used in an amount of 0.1 to 30 parts by mass, more preferably 1 to 20 parts by mass, relative to 100 parts by mass of the polymerizable monomer for shell.

The polymerization temperature of the shell layer is preferably 50° C. or more, more preferably 60 to 95° C. The polymerization reaction time is preferably 1 to 20 hours, more preferably 2 to 15 hours.

### (A-4) Washing, Filtering, Dehydrating and Drying Steps

After the polymerization is completed, preferably, the aqueous dispersion of the colored resin particles obtained by the polymerization is subjected to repeated cycles of filtering, washing (for removal of the dispersion stabilizer), dehydrating and drying, as needed, according to a known method.

Before subjected to the cycles of washing, filtering, dehydrating and drying, the aqueous dispersion of the colored resin particles can be subjected to a stripping step, for the purpose of removing volatile substances (mainly such as ether components and styrene) from the colored resin particles.

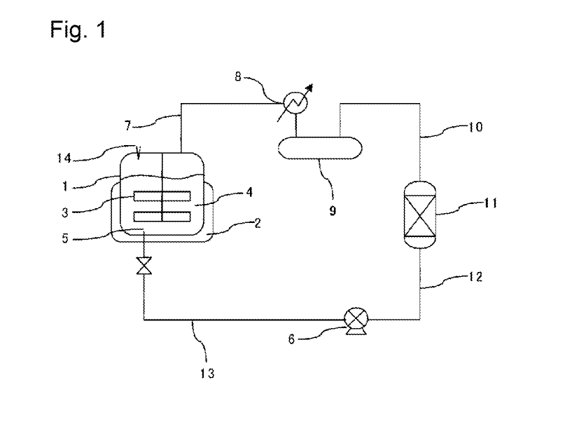

An example of the stripping step is explained now. Stripping treatment can be carried out as follows on the thus-obtained aqueous dispersion of the colored resin particles by an air injection method, using the stripping treatment system shown in FIG. 1.

First, an aqueous dispersion of colored resin particles (hereinafter referred to as aqueous dispersion 4) is diluted with ion-exchanged water to a predetermined solid concentration and then supplied to an evaporator 1. As needed, a predetermined amount of defoaming agent is put in the evaporator 1. Inert gas (e.g., nitrogen gas) or saturated water vapor is injected into the evaporator 1 to replace the gas phase part inside the evaporator with the inert gas or saturated water vapor.

Next, the evaporator 1 is heated by supplying hot water to a jacket 2, which is provided outside and in contact with the evaporator 1, while agitating the aqueous dispersion 4 with an agitator 3 at a predetermined rotational frequency, the agitator being furnished with agitating blades. After the liquid temperature of the aqueous dispersion 4 is increased to a predetermined temperature, a blower 6 is started to adjust the flow rate of the inert gas. Then, volatile substances are removed from the colored resin particles (stripping treatment) by injecting the inert gas into the aqueous dispersion through a gas intake tube 5, the tube having a gas intake part in a straight tube form. The stripping treatment can be carried out while keeping the foam level of the aqueous dispersion 4 at 90 to 95%.

After the stripping treatment is carried out for a predetermined period of time, the aqueous dispersion 4 is cooled by supplying cooling water to the jacket 2, which is provided outside and in contact with the evaporator 1, until the liquid temperature reaches 25° C. The stripping is completed when the temperature reaches 25° C.

Washing is preferably carried out by the following method: in the case of using an inorganic compound as the dispersion stabilizer, by adding an acid or alkali to the aqueous dispersion, the dispersion stabilizer is dissolved in water and then removed. In the case of using a colloid of a hardly water-soluble inorganic hydroxide as the dispersion stabilizer, it is preferable to add an acid to adjust the pH of the aqueous dispersion to pH 6.5 or less. As the acid added, there may be used inorganic acids such as sulfuric acid, hydrochloric acid and nitric acid, and organic acids such as formic acid and acetic acid. Sulfuric acid is particularly preferred, because of large removal efficiency and small pressure on production facilities.

Dehydrating and filtering can be carried out by various kinds of known methods, and the methods are not particularly limited. For example, there may be mentioned a centrifugal filtration method, a vacuum filtration method, a pressure filtration method, etc. Drying can be also carried out by various kinds of methods, and the methods are not particularly limited.

### (B) Pulverization Method

In the case of producing the colored resin particles by the pulverization method, it is carried out by the following process.

First, a binder resin, a colorant, a positively-chargeable charge control agent, a cyano group-containing hydrocarbon compound and, as needed, other additive(s) such as a release agent, are mixed by a mixer such as a ball mill, V-mixer, HENSCHEL MIXER (product name), high-speed dissolver, internal mixer, a whole burg, etc. Next, the thus-obtained mixture is kneaded by a pressure kneader, biaxial kneading extruder, roller or the like, while heating the mixture. The thus-obtained kneaded product is coarsely pulverized by a pulverizer such as a hammer mill, cutter mill, roller mill, etc. In addition, the resultant is finely pulverized by a pulverizer such as a jet mill, high-speed rotating pulverizer or the like and then classified into a desired particle diameter by a classifier such as a pneumatic classifier or airflow classifier, thus obtaining colored resin particles produced by the pulverization method.

As the raw materials used in the pulverization method, that is, as the binder resin, the colorant, the positively-chargeable charge control agent, the cyano group-containing hydrocarbon compound and, as needed, other additive(s) such as a release agent, those mentioned above under “(A) The suspension polymerization method” can be used. As well as the colored resin particles obtained by the method mentioned under “(A) Suspension polymerization method”, the colored resin particles produced by the pulverization method can be also formed into core-shell colored resin particles by the in-situ polymerization method, etc.

As the binder resin, there may be also used resins that have been widely used in toner. Concrete examples of the binder resin used in the pulverization method include polystyrene, styrene-butyl acrylate copolymer, polyester resin and epoxy resin.

### 2. Colored Resin Particles

The colored resin particles are obtained by production methods such as those mentioned under “(A) Suspension polymerization method” and “(B) Pulverization method”.

Hereinafter, the colored resin particles that constitute the toner will be explained. The colored resin particles explained below encompass both core-shell colored resin particles and other types of colored resin particles.

The colored resin particles preferably have a volume average particle diameter (Dv) of 4 to 12 μm, more preferably 5 to 10 μm. When the Dv is less than 4 μm, toner flowability is decreased and may result in poor transferability or decrease in image density. When the Dv is more than 12 μm, image resolution may be decreased.

As for the colored resin particles, the ratio (Dv/Dn) of the volume average particle diameter (Dv) to the number average particle diameter (Dn) is preferably 1.0 to 1.3, more preferably 1.0 to 1.2. When the Dv/Dn is more than 1.3, there may be a decrease in transferability, image density and resolution. The volume and number average particle diameters of the colored resin particles can be measured by a particle size analyzer (product name: Multisizer; manufactured by: Beckman Coulter, Inc.), for example.

From the viewpoint of image reproducibility, the colored resin particles of the present invention preferably have an average circularity of 0.96 to 1.00, more preferably 0.97 to 1.00, still more preferably 0.98 to 1.00.

When the colored resin particles have an average circularity of less than 0.96, thin line reproducibility may be deteriorated.

In the present invention, “circularity” is defined as a value which is obtained by dividing the circumference of a circle having the same projected area as that of a projected image of a particle by the circumference of the projected image of the particle. Also in the present invention, “average circularity” is used as a simple method for quantitatively describing the form of the particles and is an indicator that shows the degree of the surface roughness of the colored resin particles. The average circularity is 1 when the colored resin particles are perfectly spherical, and it gets smaller as the surface shape of the colored resin particles becomes more complex.

### 3. Toner Production Method

In the present invention, an external additive is attached to the surface of the colored resin particles by mixing the colored resin particles with the external additive and agitating them, thus obtaining a one-component toner (developer).

The one-component toner can be further mixed with carrier particles and agitated to obtain a two-component developer.

The agitator used for the attachment is not particularly limited, as long as it is an agitator that is able to attach the external additive to the surface of the colored resin particles. The attachment can be carried out by an agitator that is capable of mixing and agitating, such as HENSCHEL MIXER (product name; manufactured by Mitsui Mining Co., Ltd.), FM Mixer (product name; manufactured by Nippon Coke & Engineering Co., Ltd.), Super Mixer (product name; manufactured by Kawata Mfg. Co., Ltd.), Q Mixer (product name; manufactured by Nippon Coke & Engineering Co., Ltd.), Mechanofusion system (product name; manufactured by Hosokawa Micron Corporation) or Mechanomill (product name; manufactured by Okada Seiko Co., Ltd.)

As the external additive, there may be mentioned inorganic fine particles of silica, titanium oxide, aluminum oxide, zinc oxide, tin oxide, calcium carbonate, calcium phosphate, cerium oxide and so on, and organic particles of polymethyl methacrylate resin, silicone resin, melamine resin and so on. Of them, preferred are inorganic fine particles. Of inorganic fine particles, preferred are inorganic fine particles of silica and titanium oxide, and particularly preferred are inorganic fine particles of silica.

These external additives can be used alone or in combination of two or more kinds. It is particularly preferable to use two more kinds of silica particles having different particle diameters.

In the present invention, the external additive is generally used in an amount of 0.05 to 6 parts by mass, preferably 0.2 to 5 parts by mass, relative to 100 parts by mass of the colored resin particles. When the amount of the external additive added is less than 0.05 part by mass, toner transferability may lower. When the amount of the external additive added is more than 6 parts by mass, fog may be produced.

### 4. Toner of the Present Invention

The toner of the present invention is a toner which is able to keep excellent heat-resistant storage stability, increase charge stability against environmental changes, and show excellent stability even after a long period of storage.

### EXAMPLES

Hereinafter, the present invention will be explained in more detail, by way of examples and comparative examples. However, the present invention is not limited to the examples. All designations of part(s) and % are expressed on mass basis, unless otherwise noted.

### 1. Production of Toner for Developing Electrostatic Images

### Example 1

The following raw materials were mixed and agitated by an agitator. Then, the mixture was uniformly dispersed by a media type dispersing machine.
Monovinyl monomer: 75 Parts of styrene and 25 parts of n-butyl acrylate (The thus-obtained copolymer has a Tg of 44° C.)
Cyan colorant: 6 Parts of copper phthalocyanine pigment (C.I. Pigment Blue 15:3)
Positively-chargeable charge control agent: 0.5 Part of a positively-chargeable charge control resin (a quaternary ammonium base-containing copolymer (“FCA-161P” manufactured by Fujikura Kasei Co., Ltd., which is a styrene acrylic resin containing by mass of a quaternary ammonium base-containing (meth)acrylate monomer unit, Tg 60° C., Mw 21,000))
0.25 Part of a polymethacrylic acid ester macromonomer (“AA6” manufactured by TOAGOSEI Co., Ltd., Tg 94° C.)
   The following raw materials were added to the mixture, mixed and dissolved, thus obtaining a polymerizable monomer composition.
Release agent: 5 Parts of dipentaerythritol hexamyristate (solubility in styrene: 10 g or more/100 g, endothermic peak 65° C., molecular weight 1,514)
Cyano group-containing hydrocarbon compound: 0.016 Part of 2,3-diethyl-2,3-dimethylsuccinodinitrile (also known as 2,3-diethyl-2,3-dimethylbutanedinitrile, molecular weight 164, hereinafter may be referred to as DEDMSN) represented by the following formula (1a)

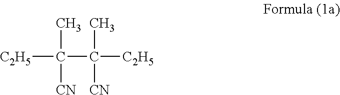

An aqueous solution of 4.8 parts of sodium hydroxide (alkali metal hydroxide) dissolved in 50 parts of ion-exchange water, was gradually added, with agitation, to an aqueous solution of 8.6 parts of magnesium chloride (water-soluble polyvalent metal salt) dissolved in 250 parts of ion-exchange water, thus preparing a magnesium hydroxide colloid dispersion (hardly water-soluble metal hydroxide colloid dispersion).

The particle diameter distribution of the magnesium hydroxide colloid obtained was measured with a particle diameter distribution analyzer (“SALD” manufactured by Shimadzu Corporation). As a result, the D50 (50% of the cumulative value of number particle diameter distribution) particle diameter was found to be 0.36 μm, while the D90 (90% of the cumulative value of number particle diameter distribution) particle diameter was found to be 0.80 μm.

To the magnesium hydroxide colloid dispersion obtained above, the polymerizable monomer composition was added at room temperature and agitated until the droplets became stable. To the resultant, the following raw materials were added:
Polymerization initiator: 5 Parts of t-butylperoxy-2-ethylbutanoate (“Trigonox 27” manufactured by Akzo Nobel, purity 98%, molecular weight 188, one-hour half-life temperature 94° C.)
Molecular weight modifier: 1.2 Parts of t-dodecyl mercaptan
Cross-linkable polymerizable monomer: 0.5 Part of divinvlbenzene
   Then, the mixture was subjected to high shear agitation with an in-line emulsification device (“EBARA MILDER” manufactured by Ebara Corporation) at a rotational frequency of 15,000 rpm for 10 minutes, thus forming droplets of the polymerizable monomer composition.

The thus-obtained suspension in which the droplets of the polymerizable monomer composition were dispersed (polymerizable monomer composition dispersion) was put in a reactor furnished with agitating blades. The reactor temperature was increased to 90° C. to initiate polymerization reaction. When the polymerization conversion rate reached 95%, the following raw materials were added thereto.
Polymerizable monomer for shell: 1 Part of methyl methacrylate
Polymerization initiator for shell: 0.1 Part of 2,2′-azobis(-methyl-N-(2-hydroxyethyl)-propionamide) (“VA-086” manufactured by Wako Pure Chemical Industries, Ltd.) dissolved in 10 parts of ion-exchange water
   The reaction was kept at 90° C. for 3 hours and stopped, thus obtaining an aqueous dispersion of core-shell colored resin particles having a pH of 9.5.

Stripping treatment was carried out as follows on the aqueous dispersion of the colored resin particles, by the air injection method and in the stripping treatment system shown in FIG. 1.

First, the aqueous dispersion of the colored resin particles (hereinafter referred to as aqueous dispersion 4) was diluted with ion-exchange water to a solid concentration of 20% and then supplied to an evaporator 1. Then, 0.1 part of a defoaming agent (“SN Defoamer 180” manufactured by San Nopco Limited) was put in the evaporator 1. Nitrogen gas was injected into the evaporator 1 to replace the gas phase part inside the evaporator with the nitrogen gas.

Next, while being agitated with an agitator 3, the aqueous dispersion 4 was heated to 80° C., the agitator being furnished with agitating blades. Then, a blower 6 was started to adjust the flow rate of the nitrogen gas to 0.6 m³/(hr·kg). Volatile substances were removed from the colored resin particles by injecting the nitrogen gas through a gas intake tube 5, the tube having a gas intake part in a straight tube form.

After the stripping treatment, the nitrogen gas passed through a gas circulation line 7 and was introduced to a condenser 8 and then to a condensation tank 9 for condensation. The condensed nitrogen gas passed through a gas circulation line 10 and was introduced to a volatile substance removal device (an adsorption tower filled with activated carbon) 11 to remove volatile substances from the nitrogen gas. The volatile substance-free nitrogen gas passed through a gas circulation line 12 and was injected into the evaporator 1 again, through the blower 6 and then through a gas circulation line 13.

The stripping treatment was carried out in the following condition.

Temperature of the aqueous dispersion 4: 80° C.

Pressure inside the evaporator 1: 101 kPa

Flow rate of the nitrogen gas: 0.6 m³/(hr·kg)

Treatment time: 6 Hours

After the six hours of treatment, the aqueous dispersion 4 was cooled to room temperature.

Thereafter, acid washing was carried out on the aqueous dispersion 4, in which sulfuric acid was added to the aqueous dispersion to adjust the pH of the aqueous dispersion to 6.5 or less, while agitating the aqueous dispersion at room temperature. Then, water washing was carried out thereon, in which water was separated from the aqueous dispersion 4 by filtration, followed by addition of another 500 parts of ion-exchange water to turn the dispersion into a slurry again. Thereafter, dehydration and the water washing were further carried out on the thus-obtained slurry repeatedly several times. After the colored resin particles were separated by filtration, the separated particles were put in a dryer and dried at 30° C. for one day.

The thus-obtained colored resin particles had a volume average particle diameter (Dv) of 9.5 μm and a particle diameter distribution (Dv/Dn) of 1.16. The thickness of the shell was calculated from the volume of the polymerizable monomer for shell and the particle diameter of the core particles (colored resin particles before subjected to shell formation) and found to be 0.03 μm. Also, the colored resin particles had a sphericity (Sc/Sr) of 1.2.

To 100 parts of the colored resin particles obtained, 0.6 part of hydrophobized fine silica particles (“TG820F” manufactured by Cabot Corporation) and 1.0 part of hydrophobized fine silica particles (“NA50Y” manufactured by Nippon Aerosil Co., Ltd.) were added and mixed with a high-speed agitator (“HENSCHEL MIXER” manufactured by Mitsui Mining Co., Ltd.), thus producing a toner for developing electrostatic images of Example 1, which is a non-magnetic one-component toner. The toner was used in the tests mentioned below.

### Example 2

A toner for developing electrostatic images of Example 2 was produced in the same manner as Example 1, except that the amount of DEDMSN added was changed from 0.016 part to 0.024 part. The toner was used in the tests mentioned below.

### Example 3

A toner for developing electrostatic images of Example 3 was produced in the same manner as Example 1, except that the amount of DEDMSN added was changed from 0.016 part to 0.032 part. The toner was used in the tests mentioned below.

### Example 4

A toner for developing electrostatic images of Example 4 was produced in the same manner as Example 1, except that 0.016 part of DEDMSN was changed to 0.028 part of 2,2,3,3-tetramethylsuccinodinitrile (also known as 2,2,3,3-tetramethylbutanedinitrile, molecular weight 136, hereinafter may be referred to as TMSN). The toner was used in the tests mentioned below. TMSN is represented by the following formula (1b):

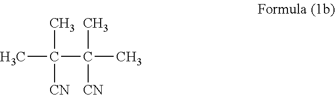

### Example 5

A toner for developing electrostatic images of Example 5 was produced in the same manner as Example 1, except that the positively-chargeable charge control agent was changed to 0.05 part of a nigrosine dye (“Bontron N-01” manufactured by Orient Chemical Industries, LTD.) from 0.5 part of the quaternary ammonium base-containing copolymer. The toner was used in the tests mentioned below.

### Comparative Example 1

A toner for developing electrostatic images of Comparative Example 1 was produced in the same manner as Example 1, except that no DEDMSN was added. The toner was used in the tests mentioned below.

### Comparative Example 2

A toner for developing electrostatic images of Comparative Example 2 was produced in the same manner as Example 1, except that the amount of DEDMSN added was changed from 0.016 part to 0.062 part. The toner was used in the tests mentioned below.

### Comparative Example 3

A toner for developing electrostatic images of Comparative Example 3 was produced in the same manner as Example 1, except that no DEDMSN was added and, as a charge control agent, 0.08 part of a negatively-chargeable charge control agent (“Spilon Black TRH” manufactured by Hodogaya Chemical Co., Ltd.) was further added. The toner was used in the tests mentioned below.

### Comparative Example 4

A toner for developing electrostatic images of Comparative Example 4 was produced in the same manner as Example 1, except that no DEDMSN was added; the polymerization initiator was changed to 2 parts of azobisisobutyronitrile from 5 parts of t-butylperoxy-2-ethylbutanoate; and the polymerization temperature was changed to 80° C. from 90° C. The toner was used in the tests mentioned below.

### 2. Evaluation of Toners for Developing Electrostatic Images

The toners of Examples 1 to 5 and Comparative Examples 1 to 4 were evaluated for their properties. Details are as follows.

### 2-1. Amount of the Cyano Group-Containing Hydrocarbon Compound Remaining in the Toner

Each toner was precisely weighed (in milligrams) to 3 g. To the 3 g toner, 27 g of ethyl acetate was added and agitated for 15 minutes. Then, 13 g of methanol was added thereto and agitated further for 10 minutes. The thus-obtained solution was left to stand to precipitate insoluble substances. The supernatant liquid of the solution was collected as a measurement sample. Then, 2 μL of the sample was injected into a gas chromatograph to quantitatively determine the amount of the cyano group-containing hydrocarbon compound remaining in the toner. The results are shown in Table 1. The gas chromatography measurement conditions are as follows.
Column: “DB-5” manufactured by Agilent Technologies, inner diameter 0.25 mm×length 30 m
Column temperature: The column temperature was kept at 40° C. for 3 minutes, increased to 130° C. at a heating rate of 10° C./min, then further increased to 230° C. at a heating rate of 20° C./min.
Injection temperature: 200° C.
FID detector temperature: 250° C.
Standard sample for quantitative determination: A solution of the cyano group-containing hydrocarbon compound in ethyl acetate and methanol

### 2-2. Heat-Resistant Storage Stability

First, 20 g of the toner was put in a container. The container was hermetically closed, immersed in a constant temperature water bath at 60° C. for 5 hours, and then removed from the bath. The toner was removed from the container onto a 42-mesh screen, keeping the toner away from vibration as much as possible, and then set in a powder measuring device (“Powder Tester PT-R” manufactured by Hosokawa Micron Corporation). The screen was vibrated at an amplitude of 1.0 mm for 30 seconds. The mass of the toner remaining on the screen was measured and used as the mass of aggregated toner. The heat-resistant storage stability (%) of the toner was calculated from the ratio (% by mass) of the mass of the toner remaining on the screen (corresponding to the mass of the aggregated toner) to the mass of the toner measured (20 g).

As the heat-resistant storage stability (%) of the toner gets smaller, the amount of the aggregated toner decreases and results in better heat-resistant storage stability.

### 2-3. Printing Test

A commercially-available non-magnetic one-component development printer was used. Printing sheets were set in the printer and the toner was put in the toner cartridge of the printer. The printer was left for one day in a normal temperature and normal humidity (N/N) environment at a temperature of 23° C. and a humidity of 50%. Then, fog values were measured as follows in a high temperature and high humidity (H/H) environment at a temperature of 30° C. and a humidity of 80%.

Solid pattern printing (image density 0%) was carried out. When printing halfway, the printer was stopped. An adhesive tape (“Scotch Mending Tape 810-3-18” manufactured by Sumitomo 3M Limited) was attached to the toner in a non-image area on the photoconductor after development. Then, the tape was removed therefrom and attached to a printing sheet. Next, the printing sheet on which the adhesive tape was attached, was measured for color tone with a spectrocolorimeter (“SE-2000” manufactured by Nippon Denshoku Industries Co., Ltd.) In the same manner, as a reference, an unused adhesive tape was attached to the printing sheet and measured it for color tone. A color difference calculated from the color tones was used as the fog value. As the fog value gets smaller, fog preferably decreases.

Thereafter, the toner cartridge was removed from the printer and put in a polyvinyl chloride bag. The bag was hermetically closed and stored in an environment at a temperature of 30° C. and a humidity of 50%, for a long period of time for 60 days. Then, the initial fog value was measured in a high temperature and high humidity (H/H) environment at a temperature of 30° C. and a humidity of 80%, and also in a low temperature and low humidity (L/L) environment at a temperature of 10° C. and a humidity of 20%.

After the above-mentioned long period of storage, continuous printing was carried out at an image density of 1%, in a normal temperature and normal humidity (N/N) environment at a temperature of 23° C. and a humidity of 50%. The fog value was measured for every 500 sheets. The number of the sheets showing a fog value of 1 or more (the number of sheets printed until the appearance of fog) was counted. The printing durability test was carried out on 15,000 printing sheets and stopped when the fog value reached 1.

The measurement and evaluation results of the toners of Examples 1 to 5 and Comparative Examples 1 to 4 are shown in Table 1, along with the type and so on of the cyano group-containing hydrocarbon compounds and the charge control agents. In Table 1, “HH Initial” means the initial fog value in the high temperature and high humidity (H/H) environment at a temperature of 30° C. and a humidity of 80%, while “LL Initial” means the initial fog value in the low temperature and low humidity (L/L) environment at a temperature of 10° C. and a humidity of 20%. Also in Table 1, “CCR” means charge control resin, while “CCA” means charge control agent. Accordingly, for example, “Positive CCR” means positively-chargeable charge control resin, while “Negative CCA” means negatively-chargeable charge control agent. Also in Table 1, “<25” means that the amount of the cyano group-containing hydrocarbon compound remaining in the toner is smaller than 25 ppm, which is a detection limit, while “>15,000” means that the fog value is less than 1 even when 15,000 printing sheets are continuously printed.

TABLE 1

| | Cyano | | | | | | | |
|---|---|---|---|---|---|---|---|---|
| | group-containing | | | | | | | |
| | hydrocarbon | | | | | | | |
| | compound | | | | | After a long period of storage | | |
| | | Remaining | | | Before a long period | | | Durability |
| | | amount | Charge control | Heat-resistant | of storage | | | (Number of |
| | Type | (ppm) | agent | storage stability | HH Initial | HH Initial | LL Initial | sheets) |
| Example 1 | DEDMSN | 150 | Positive CCR | 0.6 | 0.6 | 0.9 | 0.8 | >15,000 |
| Example 2 | DEDMSN | 220 | Positive CCR | 0.6 | 0.6 | 0.8 | 0.7 | >15,000 |
| Example 3 | DEDMSN | 290 | Positive CCR | 0.7 | 0.5 | 0.9 | 1.0 | >15,000 |
| Example 4 | TMSN | 250 | Positive CCR | 1.2 | 0.6 | 1.1 | 1.0 | 14,500 |
| Example 5 | DEDMSN | 200 | Positive CCA | 0.6 | 0.6 | 1.2 | 1.3 | 13,500 |
| Comparative | — | <25 | Positive CCR | 0.5 | 0.9 | 1.7 | 2.2 | 13,000 |
| Example 1 | | | | | | | | |
| Comparative | DEDMSN | 540 | Positive CCR | 1.2 | 0.6 | 1.9 | 1.8 | 13,000 |
| Example 2 | | | | | | | | |
| Comparative | — | <25 | Positive CCR & | 0.4 | 0.5 | 1.1 | 1.2 | 13,000 |
| Example 3 | | | Negative CCA | | | | | |
| Comparative | TMSN | 2,100 | Positive CCP | 1.8 | 1.6 | 3.1 | 2.8 | 11,000 |
| Example 4 | | | | | | | | |

### 3. Evaluation of Toners

Hereinafter, the evaluation result of the toners for developing electrostatic images will be studied with reference to Table 1.

According to Table 1, the toner of Comparative Example 1 is a toner which does not contain any cyano group-containing hydrocarbon compounds and contains the positively-chargeable charge control resin. According to Table 1, in the toner of Comparative Example 1, the amount of the aggregated toner is 0.5% by mass. Therefore, there is no problem with at least the heat-resistant storage stability.

However, as for the toner of Comparative Example 1, the initial fog value in the high temperature and high humidity (H/H) environment before a long period of storage is 0.9 and high; the initial fog value in the high temperature and high humidity (H/H) environment after a long period of storage is 1.7 and high; and the initial fog value in the low temperature and low humidity (L/L) environment after a long period of storage is 2.2 and high. Also, as for the toner of Comparative Example 1, in the printing durability test carried out in the normal temperature and normal humidity (N/N) environment, the number of sheets printed until the appearance of fog is 13,000 sheets. Therefore, it is clear that the toner of Comparative Example 1 which does not contain any cyano group-containing hydrocarbon compounds, is likely to generate initial fog and has poor charge stability, with or without a long period of storage.

According to Table 1, the toner of Comparative Example 2 is a toner which contains 540 ppm of DEDMSN and the positively-chargeable charge control resin. According to Table 1, as for the toner of Comparative Example 2, the initial fog value in the high temperature and high humidity (H/H) environment before a long period of storage is 0.6. Therefore, there is no problem with at least the charge stability before a long period of storage.

However, as for the toner of Comparative Example 2, the amount of the aggregated toner is 1.2% by mass and high; the initial fog value in the high temperature and high humidity (H/H) environment after a long period of storage is 1.9 and high; and the initial fog value in the low temperature and low humidity (L/L) environment after a long period of time is 1.8 and high. Also, as for the toner of Comparative Example 2, in the printing durability test carried out in the normal temperature and normal humidity (N/N) environment, the number of sheets printed until the appearance of fog is 13,000 sheets. Therefore, it is clear that the toner of Comparative Example 2 in which the content of the cyano group-containing hydrocarbon compound is more than 500 ppm, has poor heat-resistant storage stability and, as a result, the toner is likely to generate initial fog after a long period of storage and has poor printing durability.

According to Table 1, the toner of Comparative Example 3 is a toner which does not contain any cyano group-containing hydrocarbon compounds and contains the positively-chargeable charge control resin and the negatively-chargeable charge control agent. According to Table 1, in the toner of Comparative Example 3, the amount of the aggregated toner is 0.4% by mass. Also according to Table 1, as for the toner of Comparative Example 3, the initial fog value in the high temperature and high humidity (H/H) environment before a long period of storage is 0.5; the initial fog value in the high temperature and high humidity (H/H) environment after a long period of storage is 1.1; and the initial fog value in the low temperature and low humidity (L/L) environment after a long period of storage is 1.2. Therefore, as for the toner of Comparative Example 3, there is no problem with at least the heat-resistant storage stability and fog.

However, as for the toner of Comparative Example 3, in the printing durability test carried out in the normal temperature and normal humidity (N/N) environment, the number of sheets printed until the appearance of fog is 13,000 sheets. Therefore, it is clear that the toner of Comparative Example 3 which does not contain any cyano group-containing hydrocarbon compounds and which contains the positively-chargeable charge control resin and the negatively-chargeable charge control agent, shows poor charge stability after a long period of storage.

According to Table 1, the toner of Comparative Example 4 is a toner which contains TMSN in an amount of 2,100 ppm and the positively-chargeable charge control resin.

According to Table 1, in the toner of Comparative Example 4, the amount of the aggregated toner is 1.8% by mass and high. This is the highest amount among the toners of Examples 1 to 5 and Comparative Examples 1 to 4. Also according to Table 1, as for the toner of Comparative Example 4, the initial fog value in the high temperature and high humidity (H/H) environment before a long period of storage is 1.6 and high; the initial fog value in the high temperature and high humidity (H/H) environment after a long period of storage is 3.1 and high; and the initial fog value in the low temperature and low humidity (L/L) environment after a long period of storage is 2.8 and high. These three initial fog values are each the highest among the toners of Examples 1 to and Comparative Examples 1 to 4. As for the toner of Comparative Example 4, in the printing durability test carried out in the normal temperature and normal humidity (N/N) environment, the number of sheets printed until the appearance of fog is 11,000 sheets. This is the lowest number among Examples 1 to 5 and Comparative Examples 1 to 4.

Therefore, it is clear that the toner of Comparative Example 4 in which azobisisobutyronitrile (AIBN) is contained as the polymerization initiator and thus TMSN is contained in an amount of as much as 2,100 ppm, is extremely inferior in both heat-resistant storage stability and printing durability.

According to Table 1, the toners of Examples 1 to 5 are toners which contain DEDMSN or TMSN in an amount of 150 to 290 ppm and the positively-chargeable charge control resin or agent.

According to Table 1, in the toners of Examples 1 to 5, the amount of the aggregated toner is 1.2% by mass or less and low. Also according to Table 1, as for the toners of Examples 1 to 5, the initial fog value in the high temperature and high humidity (H/H) environment before a long period of storage is 0.6 or less and low; the fog value in the high temperature and high humidity (H/H) environment after a long period of storage is 1.2 or less and low; and the initial fog value in the low temperature and low humidity (L/L) environment after a long period of storage is 1.3 or less and low. Also according to Table 1, as for the toners of Examples to 5, in the printing durability test carried out in the normal temperature and normal humidity environment (N/N), the number of sheets printed until the appearance of fog is as large as 13,500 or more.

Therefore, it is clear that the toners of Examples 1 to 5 which contain the cyano group-containing hydrocarbon compound in an amount of 80 to 500 ppm and the positively-chargeable charge control resin or agent, are toners which are able to keep excellent heat-resistant storage stability, increase charge stability against environmental changes such as temperature change or humidity change, and show excellent stability even after a long period of storage.

According to Table 1, the toners of Examples 1 to 3 are toners which contain DEDMSN in an amount of 150 to 290 ppm and the positively-chargeable charge control resin.

According to Table 1, in the toners of Examples 1 to 3, the amount of the aggregated toner is 0.7% by mass or less and extremely low. Also according to Table 1, as for the toners of Examples 1 to 3, the initial fog value in the high temperature and high humidity (H/H) environment before a long period of storage is 0.6 or less and low; the initial fog value in the high temperature and high humidity (H/H) environment after a long period of storage is 0.9 or less and extremely low; and the initial fog value in the low temperature and low humidity (L/L) environment after a long period of storage is 1.0 or less and extremely low. Also according to Table 1, as for the toners of Examples 1 to 3, the fog value is less than 1 even in the case of continuous printing on 15,000 sheets in the normal temperature and normal humidity (N/N) environment, so that the toners have excellent printing durability.

### REFERENCE SIGNS LIST

1. Evaporator
2. Jacket
3. Agitator furnished with agitating blades
4. Aqueous dispersion of colored resin particles
5. Gas intake tube
6. Blower
7. Gas circulation line
8. Condenser
9. Condensation tank
10. Gas circulation line
11. Volatile substance removal device
12. Gas circulation line
13. Gas circulation line
14. Non-contact foam level meter

1. A toner for developing electrostatic images, comprising an external additive and colored resin particles comprising a binder resin, a colorant and a charge control agent,
wherein the charge control agent is a positively-chargeable charge control agent, and
wherein the toner further contains 80 to 500 ppm of a cyano group-containing hydrocarbon compound having a molecular weight of 100 to 300.

2. The toner for developing electrostatic images according to claim 1, wherein the charge control agent is a positively-chargeable charge control resin.

3. The toner for developing electrostatic images according to claim 1, wherein the charge control agent is a charge control resin containing a quaternary ammonium base.

4. The toner for developing electrostatic images according to claim 1, wherein the cyano group-containing hydrocarbon compound has a molecular structure represented by the following general formula (1): 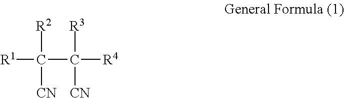
wherein R¹ to R⁴ each independently represent a hydrocarbon group having 1 to 4 carbon atoms.

5. The toner for developing electrostatic images according to claim 1, wherein the cyano group-containing hydrocarbon compound has a molecular structure represented by the following general formula (2): 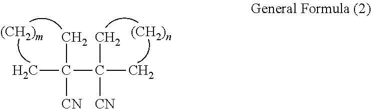
wherein “m” and “n” each independently represent an integer of 1 to 4.

6. The toner for developing electrostatic images according to claim 1, wherein the content of the cyano group-containing hydrocarbon compound is 150 to 300 ppm.
